(19) United States
(12) Patent Application Publication
(10) Pub. No.: US 2012/0013211 A1
(43) Pub. Date: Jan. 19, 2012

(54) ELECTRIC MOTOR HAVING A SELECTIVELY ADJUSTABLE BASE SPEED

(75) Inventors: Bradley D. Chamberlin, Pendleton, IN (US); Balazs Palfai, Fishers, IN (US)

(73) Assignee: REMY TECHNOLOGIES, L.L.C., Pendleton, IN (US)

(21) Appl. No.: 12/838,095

(22) Filed: Jul. 16, 2010

(51) Int. Cl. H02K 7/116

(52) U.S. Cl. 310/83

(57) ABSTRACT

An electric machine includes a stator mounted within the housing, and a transmission member mounted within the housing and surrounded at least in part by the stator. The transmission member includes a gear mechanism operatively coupled to an output shaft. The transmission mechanism is rotatable relative to the stator.

### BACKGROUND OF THE INVENTION

Exemplary embodiments pertain to the art of electric machines and, more particularly, to an electric machine having a selectively adjustable base speed.

Electric machines are designed to have a fixed number of winding sets or poles, which determine a base speed. Base speed for a particular motor is a motor output shaft speed in which a constant torque output can no longer be maintained as a result of field weakening controls to provide constant power. That is, up to base speed, the motor provides relatively constant torque and variable power. Above base speed, the motor provides variable torque and relatively constant power, up to a maximum speed of the machine. A peak efficiency point of the electric motor is typically at or near the base speed point of the motor. For example, a particular electric motor is designed to have a base speed of 2000 revolutions per minute (RPM). At 2000 rpm, the motor will have a particular torque output and operate at about 95% efficiency. Deviations from the base speed result in negative changes in efficiency. For example, increasing the operating speed of the electric machine to 4000 rpm will not only lower torque output but also result in about a 5% reduction in efficiency. Further increasing the operating speed to, for example, 6000 rpm will cause a further reduction in output torque and lower efficiency about another 10%. Based on the above, changes in user requirements, e.g., new higher speed machinery, processes etc, will require either a purchase of a costly new electric machine, or operating the existing electric machine at significantly less than peak efficiency.

### BRIEF DESCRIPTION OF THE INVENTION

Disclosed is an electric machine including a housing, a stator mounted within the housing, and a transmission member mounted within the housing and surrounded at least in part by the stator. The transmission member includes a gear mechanism operatively coupled to an output shaft. The transmission mechanism is rotatable relative to the stator.

Also disclosed is a method of selectively adjusting a base speed of an electric motor. The method includes inducing an electro-motive force between a stator and a plurality of rotor laminations. The rotor laminations are mounted to a transmission member. The method also includes imparting a rotational force to the transmission member through the plurality of rotor laminations, selectively engaging a gear mechanism to establish a desired output speed for the electric motor, and driving an output shaft operatively coupled to the gear mechanism at the desired output speed.

### BRIEF DESCRIPTION OF THE DRAWINGS

The following descriptions should not be considered limiting in any way. With reference to the accompanying drawings, like elements are numbered alike:

FIG. 1 depicts an electric machine including a transmission member that establishes a selectively adjustable base speed in accordance with an exemplary embodiment;

FIG. 2 depicts the transmission member of the electric machine of FIG. 1;

FIG. 3 depicts a graph illustrating output speed (rpm) versus torque (N-m) at select base speeds of the electric machine of FIG. 1; and

FIG. 4 depicts a transmission member of the electric machine in accordance with another exemplary embodiment.

### DETAILED DESCRIPTION OF THE INVENTION

A detailed description of one or more embodiments of the disclosed apparatus and method are presented herein by way of exemplification and not limitation with reference to the Figures.

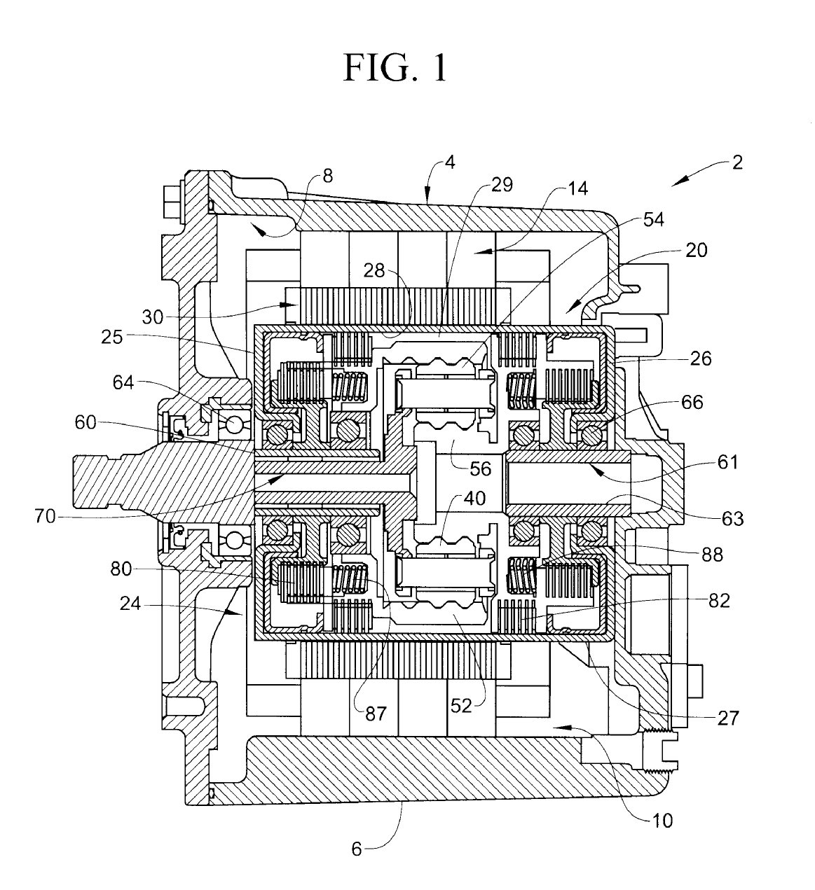

With reference to FIG. 1, an electric machine in accordance with an exemplary embodiment is indicated generally at 2. Electric machine 2 includes a housing 4 having an outer surface 6 and an inner surface 8 that defines an interior portion 10. Electric machine 2 includes a stator 14 that, in the exemplary embodiment shown, is secured to inner surface 8 of housing 4. Electric machine 2 is also shown to include a rotor/transmission member 20 that is rotatably mounted relative to stator 14. As shown, transmission member 20 includes a hub member 24 having a first end 25 that extends to a second end 26 through an outer surface 27 and an inner surface 28 that defines an interior portion 29. A plurality of laminations 30 are secured to outer surface 27. As will be detailed more fully below, an electro-motive force is generated between stator 14 and laminations 30 causing transmission member 20 to rotate.

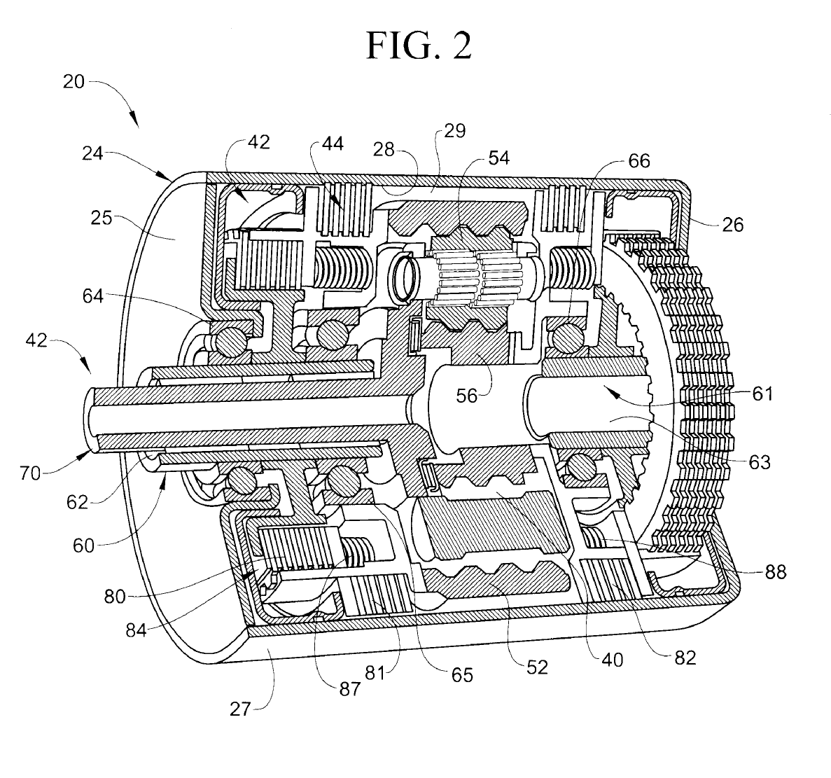

As best shown in FIG. 2, transmission member 20 includes a gear mechanism 40, a drive system 42, and a clutch system 44. In accordance with one aspect of the exemplary embodiment, gear mechanism 40 is a planetary gear set that includes a ring gear 52, a planet gear 54, and a sun gear 56 that is operatively coupled to drive system 42. In accordance with one aspect of the exemplary embodiment, gear system 40 includes an over-drive gear, and a direct drive gear. In accordance with another aspect, gear mechanism 40 includes an under-drive gear and a direct drive gear. In accordance with still another aspect, gear mechanism 40 includes an over-drive gear and an under-drive gear. Drive system 42 includes a stationary shaft 60 and stationary member 61 each having a hollow interior portion 62 and 63 respectively. Stationary shaft 60 and stationary member 61 are fixedly mounted to housing 4 and extend into first and second ends 25 and 26 of hub member 24. Drive system 42 is also shown to include a plurality of bearings 64-66 that are mounted between stationary shaft 60 and stationary member 61 and hub member 24. Bearings 64-66 allow hub member 24 to rotate relative to stationary shaft 60 and stationary member 61 and, by extension, stator 14. Drive system 42 further includes an output shaft 70 that is operatively coupled to sun gear 56. With this arrangement, gear mechanism 40 translates rotation of housing 24 to a rotation of output shaft 70 at one of a plurality of selected base speeds in a manner that will be discussed more fully below.

In order to establish the plurality of selected base speeds for output shaft 70, clutch system 44 includes a plurality of clutches 80-82 that are selectively engaged by a piston 84 and disengaged by return springs 87 and 88. Clutches 80-82 are selectively actuated to engage select ones of ring gear 52 and planet gear 54 to establish the plurality of selected base speeds for output shaft 70. Clutches 80-82 are positioned in a first or disengaged configuration directing gear mechanism 40 to establish a 1:1 ratio between revolutions of hub member 24 and output shaft 70, in a second configuration to direct gear mechanism 40 to establish a 1:2 ratio between revolutions of hub member 24 and output shaft 70, an in a third configuration to direct gear mechanism 40 to establish a 1:3 ratio between revolutions of hub member 24 and output shaft 70. With this arrangement, ring gear 52, planet gear 54 and sun gear 56 comprise a direct drive gear system and an over-drive gear system. In accordance with another aspect of the exemplary embodiment, ring gear 52, planet gear 54 and sun gear 56 comprise a direct drive gear system and an under-drive gear system in which, hub member 24 and output shaft 70 rotate in a 1:1 ratio, a 1:2 ratio, and a 1:3 ratio.

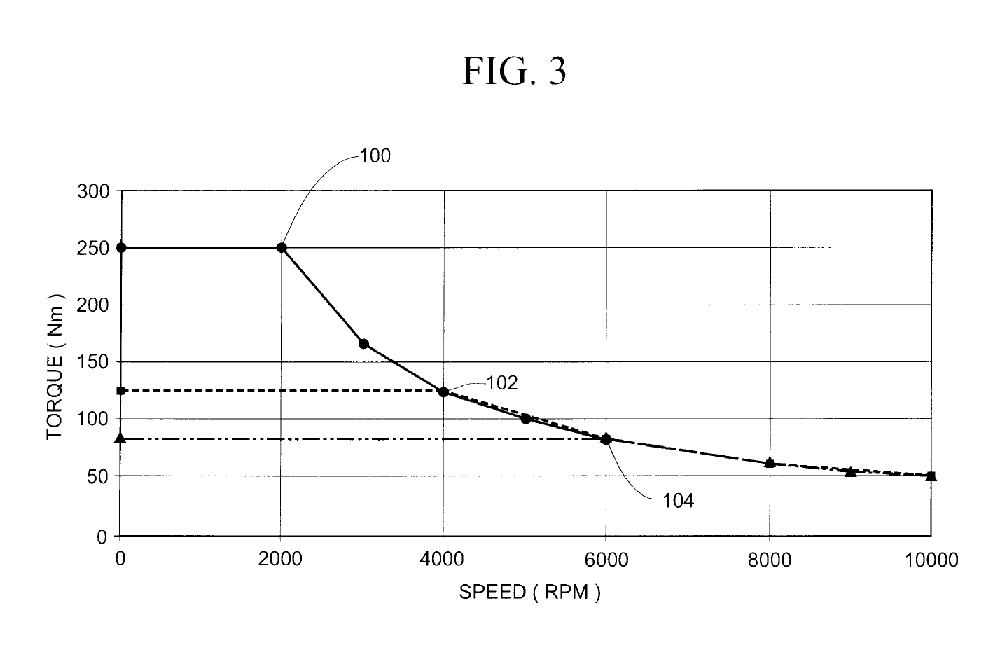

In accordance with an exemplary embodiment, when clutches 80-82 are in the first configuration, both hub member 24 and output shaft 70 rotate at the design base speed of electric machine 2 established by stator 14 and laminations 30. At the base speed, output shaft 70 rotates at a defined number of revolutions per minute (rpm) to produce a defined torque output as indicated at 100 in FIG. 3. At the designed base speed, electric machine is operating at about 95% efficiency. The efficiency is generally governed by internal losses in gear mechanism 40, which operates at about 94% efficiency, and internal frictional losses of electric machine 2. When clutches are in the second configuration, hub member 24 rotates at the designed base speed, e.g., 2,000 rpm, while output shaft 70 rotates, in the exemplary embodiment shown, at a second, higher output base speed, e.g., 4,000 rpm, such as indicated at 102 in FIG. 3. In this configuration, overall efficiency of electric machine 2 is at about 90%. More specifically, by operating electric machine 2 at the base speed, and only increasing the speed of output shaft 70, internal losses are minimized. Similarly, when clutches 80-82 are in the third configuration, hub member 24 rotates at the design base speed, e.g., 2,000 rpm, while output shaft 70 rotates, in the exemplary embodiment shown, at a third, still higher, output base speed, e.g., 6,000 rpm, such as indicated at 104 in FIG. 3. In this configuration, overall efficiency of electric machine 2 is at about 90%. Once again, by operating electric machine 2 at the design base speed, and only increasing the output base speed of the output shaft 70, internal losses are minimized.

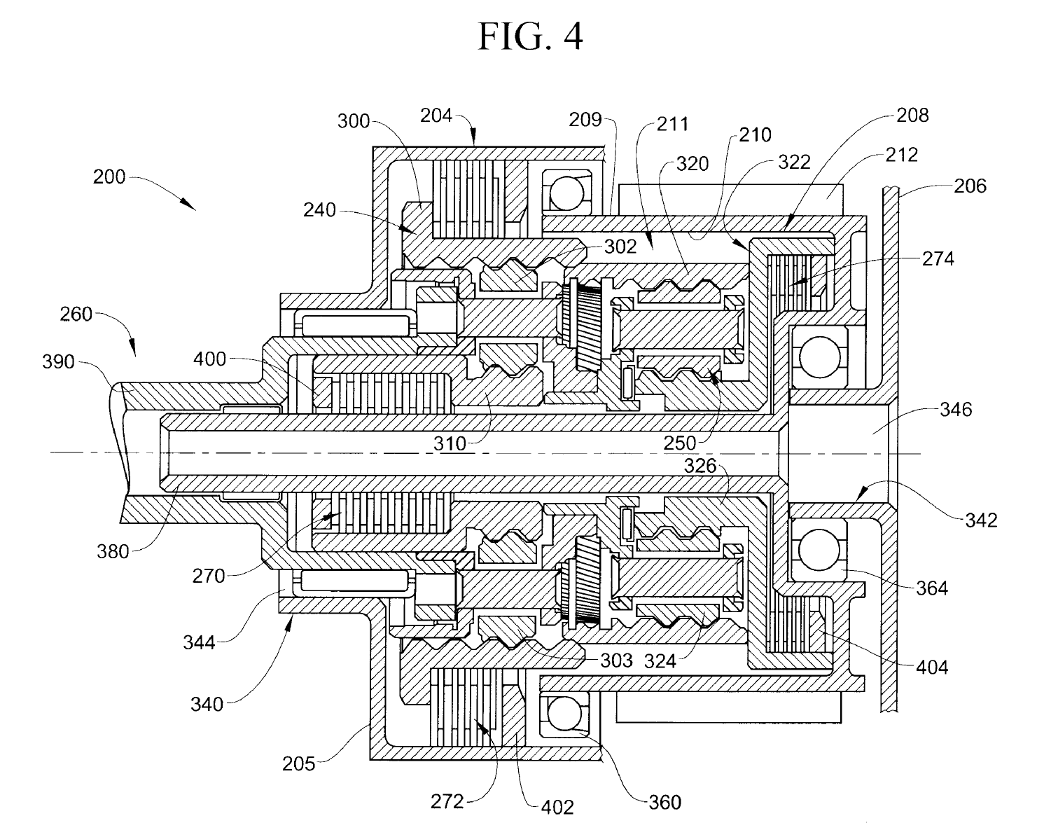

Reference will now be made to FIG. 4 in describing a transmission member 200 constructed in accordance with another aspect of the exemplary embodiment. Transmission member 200 includes a housing 204 having a first end 205 that extends to a second end 206, and a hub member 208 having an outer surface 209, and an inner surface 210 that defines an interior portion 211. A plurality of laminations 212 are secured to outer surface 209 of hub member 208. Transmission member 200 includes a first gear mechanism 240, a second gear mechanism 250, a drive system 260, and a plurality of clutch systems 270, 272, and 274 arranged, at least in part, within interior portion 211. In accordance with one aspect of the exemplary embodiment, first gear system 240 is a planetary gear set that includes a ring gear 300, a plurality of planet gears, two of which are indicated at 302 and 303, and a sun gear 310 that is operatively coupled to drive system 260. Similarly, second gear system 250 is a planetary gear set that includes a ring gear 320, a plurality of planet gears, two of which are indicated at 322 and 324, and a sun gear 342 that is operatively coupled to drive system 260. In accordance with one aspect of the exemplary embodiment, first gear system 240 comprises an over-drive gear, and a direct drive gear, and second gear system 250 comprises an under-drive gear and a direct drive gear. Of course first and/or second gear systems 240 and 250 could also comprise an over-drive gear and an under-drive gear.

Drive system 260 includes first and second stationary members 340 and 342 each having a hollow interior portion 344 and 346 respectively. First stationary member 340 extends through first end 205 of housing 204 and second stationary member 342 projects from second end 206 of housing 204. Drive system 260 is also shown to include a plurality of bearings 360 and 364 that are mounted between first and second stationary members 340 and 342 and hub member 208. Bearings 360 and 364 allow hub member 208 to rotate relative to stationary members 340 and 342 and, by extension, stator 14. Drive system 260 further includes an inner hub 380 that is fixedly mounted to hub member 208 and operatively coupled to sun gear 310 of first gear system 240 and an output shaft 390 that is operatively connected to sun gear 326 of second gear system 250. With this arrangement, first and second gear mechanisms 240 and 250 translate rotation of hub member 208 to a rotation of inner hub 380 and output shaft 390 at one of a plurality of selected base speeds based upon a state; e.g., engaged and disengaged, of clutches 270, 272, and 274 in a manner that will be discussed more fully below.

In order to establish the plurality of selected base speeds for output shaft 70, clutch systems 270, 272 and 274 are selectively engaged by corresponding pistons 400, 402 and 404 and disengaged by return springs (not shown). Clutch system 270 is selectively engaged to lock sun gear 310 of first gear system 240, clutch system 272 is selectively engaged to lock sun gear 242 of second gear system 250, and clutch system 274 is selectively engaged to lock ring gear 300 of first gear system 240. With this arrangement, clutch system 270 is disengaged and clutch systems 272 and 274 are engaged to establish first configuration that results in a first output speed for electric machine 2. To establish a second speed, clutch systems 270 and 272 are engaged and clutch system 274 is disengaged to establish a second configuration. Finally, to establish a third speed for electric machine 2, clutch systems 270 and 274 are engaged and clutch system 272 is disengaged to establish a third configuration. The particular speed will depend upon the particular configuration of first and second gear systems 240 and 250.

In accordance with an exemplary embodiment, when clutches 270, 272, and 274 are in the first configuration, both hub member 208, inner hub 380 and output shaft 390 rotate at the base speed. At the base speed, inner hub 380 and output shaft 390 rotate at a defined number of revolutions per minute (rpm) to produce a defined torque output. At the designed base speed, electric machine 2 is operating at about 95% efficiency. The efficiency is generally governed by internal losses in gear mechanism 240 and 250, which operate at about 94% efficiency, and internal frictional losses of electric machine 2. When in the second configuration, hub member 208 rotates at the designed base speed, e.g., 2,000 rpm, while inner hub 380 and output shaft 390 rotate at the second output base speed, e.g., 4,000 rpm. In this configuration, overall efficiency of electric machine 2 is at about 90%. More specifically, by operating electric machine 2 at the base speed, and only increasing the speed of inner hub 380 and output shaft 390, internal losses are minimized. Similarly, when in the third configuration, hub member 204 rotates at the design base speed, e.g., 2,000 rpm, while output shafts 380 and 390 rotate at the third base speed, e.g., 6,000 rpm. In this configuration, overall efficiency of electric machine 2 is at about 90%. Once again, by operating electric machine 2 at the design base speed, and only increasing the output base speed of the output shafts 380 and 390 internal losses are minimized.

Without the base speed shifting motor of the exemplary embodiments, resulting efficiency levels of a prior art machine at various output shaft speeds may have been 95% at 2,000 rpm, 88% at 4,000 rpm, and 82% at 6,000 rpm. Thus it should be understood that the base speed shifting electric machine in accordance with the exemplary embodiment provides a substantial efficiency increase over prior art non-base speed shifting machines.

At this point it should be understood that the exemplary embodiment describe an electric machine that is internally operated at the base speed while producing an output base that is either selectively higher, or lower. In essence the electric machine in accordance with the exemplary embodiment is configured to produce a selectively adjustable output base speed that has a minimal effect on operating efficiency. In this manner, users can incorporate the electric machine into a wide range of applications that utilize various operating speeds without requiring the purchase of new motors, or operating under sub-optimal conditions.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. An electric machine comprising:
a housing;
a stator mounted within the housing; and
a transmission member mounted within the housing and surrounded at least in part by the stator, the transmission member including a gear mechanism operatively coupled to an output shaft, the transmission mechanism being rotatable relative to the stator.

2. The electric machine according to claim 1, wherein the transmission member includes a hub member having an outer surface and an inner surface that defines an interior portion, the gear mechanism being arranged within at least a portion of the interior portion of the hub member.

3. The electric machine according to claim 2, further comprising: a plurality of laminations fixedly mounted to the hub member.

4. The electric machine according to claim 1, wherein the gear mechanism includes at least one planetary gear set, the at least one planetary gear set establishing a speed for the output shaft.

5. The electric machine according to claim 4, wherein the transmission member includes a clutch system operatively coupled to the gear mechanism, the clutch system having a plurality of clutches that are selectively activated to establish each of the plurality of speeds of the output shaft.

6. The electric machine according to claim 2, wherein the gear mechanism selectively defines a first speed for the output shaft, a second speed for the output shaft and a third speed for the output shaft, the second speed being greater than the first speed and the third speed being greater than the second speed.

7. The electric machine according to claim 6, wherein the first speed defines a 1:1 ratio between revolutions of the hub member and revolutions of the output shaft, the second speed defines a 1:2 ratio between revolutions of the hub member and revolutions of the output shaft, and the third speed defines a 1:3 ratio between revolutions of the hub member and revolutions of the output shaft.

8. The electric machine according to claim 1, wherein the transmission member defines a rotor portion of the electric machine.

9. The electric machine according to claim 8, further comprising: a plurality of rotor laminations mounted directly to the transmission member.

10. The electric machine according to claim 1, wherein the gear mechanism includes at least one over-drive gear and one direct drive gear.

11. The electric machine according to claim 1, wherein the gear mechanism includes at least one under-drive gear and one direct drive gear.

12. The electric machine according to claim 1, wherein the gear mechanism includes at least one under-drive gear and at least one over-drive gear.

13. The electric machine according to claim 1, wherein the gear mechanism comprises a planetary gear set including a ring gear, a planet gear and a sun gear.

14. The electric machine according to claim 1, wherein the gear mechanism comprises a first gear mechanism and a second gear mechanism.

15. The electric machine according to claim 14, wherein each of the first and second gear mechanisms comprise planetary gear sets.

16. A method of selectively adjusting a base speed of an electric motor, the method comprising:
inducing an electro-motive force between a stator and a plurality of rotor laminations, the rotor laminations being mounted to a transmission member;
imparting a rotational force to the transmission member through the plurality of rotor laminations;
selectively engaging a gear mechanism to establish a desired output speed for the electric motor; and
driving an output shaft operatively coupled to the gear mechanism at the desired output speed.

17. The method of claim 16, wherein selectively engaging the gear mechanism includes operating at least one planet gear set to establish a first speed for the output shaft, a second speed for the output shaft and a third speed for the output shaft, the second speed being greater than the first speed and the third speed being greater than the second speed.

18. The method of claim 17, wherein establishing the first speed includes creating a 1:1 ratio between revolutions of the plurality of laminations and revolutions of the output shaft, establishing the second speed includes creating a 1:2 ratio between revolutions of the plurality of laminations and revolutions of the output shaft, and establishing the third speed includes creating a 1:3 ratio between revolutions of the plurality of laminations and revolutions of the output shaft.

19. The method of claim 17, wherein driving the output shaft includes rotating the output shaft through at least one over-drive gear and through one direct drive gear.

20. The method of claim 17, wherein driving the output shaft includes rotating the output shaft through at least one under-drive gear and through one direct drive gear.
